(19) United States
(12) Patent Application Publication
(10) Pub. No.: US 2008/0243808 A1
(43) Pub. Date: Oct. 2, 2008

(54) BAD WORD LIST

(75) Inventors: John RIEMAN, Helsinki (FI); Minna Hekanaho, Oulu (FI); Minna Koutonen, Oulu (FI); Tero Rantonen, Oulu (FI)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/693,134

(22) Filed: Mar. 29, 2007

(51) Int. Cl. G06F 17/30

(52) U.S. Cl. 707/5; 707/E17.064

(57) ABSTRACT

A mobile communication apparatus including enabling of character input and a first comparison of the inputted characters with characters in a predictive text dictionary, a second comparison of matches in the predictive text dictionary comparison with characters in a exception list, and taking action depending on the matches in the second comparison. A corresponding application, apparatus, user interface, and computer program is also disclosed.

### FIELD

The disclosed embodiments relate to methods for handling inappropriate words in a predictive text system in a portable apparatus, a rendering application, a portable apparatus comprising a display, means for navigating, and a computer-readable medium having computer-executable components.

### BACKGROUND

Methods for entering text into computing and communication apparatuses are well known in the art.

While some computing and communication apparatuses, such as personal computers, palmtop computers, and some mobile phones have been equipped with full QWERTY keyboards for alphanumeric text entry, many other computing and communication apparatuses, such as mobile phones, PDAs, and PDTs, are only equipped with limited or no keyboards. Entering text into computing and communication apparatuses with limited or no keyboards can be done in several ways. If the apparatus have no keyboard, or keys, the text can be entered either by writing the text on a special surface, e.g. the screen of the apparatus, with a stylus, or by tapping on a virtual keyboard displayed on the apparatuses screen. Text entering using a keyboard with a limited number of keys is often done by pressing (tapping) a key a varying number of times, generally within a limited period of time, to input a specific letter. This technique is known as multi-tap.

However, entering text via multi-tap or with a stylus is quite cumbersome, especially if large quantities of text are going to be entered. Therefore, a number of text entering systems have been developed to facilitate and to speed-up the text entering. These systems, often referred to as single-tap system with predictive text technologies, uses predictive letter patterns to allow the user to enter text by press the keys as few times as possible.

The predictive text entering system uses a predictive text dictionary to “intelligently guess” which character(s) or word(s) the user wants to enter. The predictive text dictionary is essentially a list of character strings, words, acronyms, abbreviations, etc. that is used to predict which word that is being inputted by the user. For example, let's say the user wants to enter ‘hello’ into a text message on a mobile phone. If the user enters the characters by multi-tap the user needs to enter the following key sequence;

the user presses 4, 4 for ‘h’,
then the user presses 3, 3 for ‘e’,
then the user presses 5, 5, 5 for ‘l’,
then the user presses 5, 5, 5 for ‘l’,
then the user presses 6, 6, 6 for ‘o’,

When the user uses a single-tap system with a predictive text system the user only has to enter the following key sequence;

the user presses 4, the systems displays i, h, g, 4.
then the user presses 3 the systems displays he, if, id.
then the user presses 5 the systems displays gel, hell.
then the user presses 5 the systems displays hell, hello.
then the user presses 6 (or chooses ‘hello’ from the list displayed on the screen) and the systems displays ‘hello’.

If the word that the user wants to enter appears as a suggestion in the displayed list, the user can maneuver and choose the word directly from the displayed list instead of continue entering it by pressing keys. The predictive text system reduces the overall time for entering text into an apparatuses with a limited keyboard significantly.

However, there are several problems that can occur when using a predictive text system. It is well known that users, when entering text, tend to watch the keys on the keyboard when typing instead of the screen. An erroneous tying can therefore result in that a “wrong” word is predicted and consequently entered into the text message. These mistakes can be quite funny when it happens among friends but it can be quite serious if it happens in a business, cultural, or religious context. The most obscene words are often omitted from the predictive text dictionary but there are still many borderline words left, which in some context can generate problems and even lead to legal issues.

Another problem with predictive text systems may occur in corporate or government settings where certain names, words, expressions, etc. not should be used in communications between employees since it leaves an electronic or paper trail. In this case the employer or the government wants to make sure that a “wrong” word suggested by a predictive text system is not used or accidentally used. Parents, religious leaders, leaders of clubs, etc. may in the same manner want to control or limit the language used, i.e. limit what words that are predicted and made available, by their children, followers, members, etc., in communication with other people.

### SUMMARY

In view of the above, it would be advantageous to solve or at least reduce the problems discussed above. In particular, it would be advantageous to provide a way of controlling inappropriate words being suggested to a user in a portable apparatus.

According to a first aspect of the disclosed embodiments, there is provided a method for a portable apparatus, comprising enabling inputting of characters, further enabling a first comparison of said inputted characters with characters in a list, further enabling a second comparison of matches in said first comparison with characters in a exception list, and taking action depending on the matches in said second comparison.

The method may comprise modifying said list.

The method may comprise modifying said exception list.

The method may comprise an action restricting character input depending on said matches in at least one of said first and second comparison.

The method may comprise an action displaying information depending on said matches in at least one of said first and second comparison.

The method may comprise displaying matches from said first and second comparisons in a display list.

The method may comprise enabling selection of said matches displayed in said display list.

The method may comprise an action restricting said displaying of matches from said first and second comparisons in a display list.

The method may comprise an action restricting said enabling selection of matches from said first and second comparisons in a display list.

According to a second aspect of the disclosed embodiments, there is provided a rendering application for an portable apparatus comprising a display and navigation means, said application causing enabling of character inputting, enabling a first comparison of said inputted characters with characters in a list, enabling a second comparison of matches in said first comparison with characters in a exception list, and taking action depending on the matches in said second comparison.

According to a third aspect of the disclosed embodiments, there is provided an apparatus arranged to cause enabling of character inputting, enabling a first comparison of said inputted characters with characters in a list, enabling a second comparison of matches in said first comparison with characters in a exception list, and taking action depending on the matches in said second comparison.

According to a fourth aspect of the disclosed embodiments, there is provided a computer-readable medium having computer-executable components comprising instructions for enabling inputting characters, enabling a first comparison of said inputted characters with characters in a list, enabling a second comparison of matches in said first comparison with characters in a exception list, and taking action depending on the matches in said second comparison.

According to a fifth aspect of the disclosed embodiments, there is provided a user interface comprising a display, and an input receiver, wherein the user interface is arranged to enable a portable apparatus for character input where said inputted characters are compared in a first comparison, with words in a list, and a second comparison, with words in an exception list, and where matches of said comparisons are listed in a display list, and to display said display list in said display.

The second, third, fourth, and fifth aspects of the disclosed embodiments may be combined in any way with the features of the first aspect of the disclosed embodiments.

In the above description a renderer should be interpreted as a functional block applicable to any communication device, such as a mobile phone, capable of performing at least one of the following tasks; inputting, taking action, comparing, listing, enabling, and updating.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

Other, features and advantages of the disclosed embodiments will appear from the following detailed disclosure, from the attached dependent claims as well as from the drawings.

### BRIEF DESCRIPTION OF THE DRAWINGS

The above, as well as additional, features and advantages of the disclosed embodiments will be better understood through the following illustrative and non-limiting detailed description of preferred embodiments, with reference to the appended drawings, where the same reference numerals will be used for similar elements, wherein:

FIG. 1 shows a mobile communication apparatus according to an embodiment;

FIG. 2 shows a flow chart describing character input with a common predictive text dictionary; and

FIG. 3 shows a display view in a mobile communication apparatus according to an embodiment; and

FIG. 4 shows a display view in a mobile communication apparatus according to an embodiment; and

FIG. 5 shows a flowchart of one embodiment; and

FIG. 6 shows a display view in a mobile communication apparatus according to an embodiment; and

FIG. 7 shows a display view in a mobile communication apparatus according to an embodiment; and

FIG. 8 shows a display view in a mobile communication apparatus according to an embodiment; and

FIG. 9 shows a display view in a mobile communication apparatus according to an embodiment; and

FIG. 10 shows a display view in a mobile communication apparatus according to an embodiment;

FIG. 11 shows a display view in a mobile communication apparatus according to an embodiment;

FIG. 12 shows a display view in a mobile communication apparatus according to an embodiment;

FIG. 13 shows a display view in a mobile communication apparatus according to an embodiment;

FIG. 14 shows a display view in a mobile communication apparatus according to an embodiment;

FIG. 15 illustrates a computer readable medium according to an embodiment; and

FIG. 16 illustrates an exemplary user interface of the disclosed embodiments.

### DETAILED DESCRIPTION OF PREFERRED EMBODIMENTS

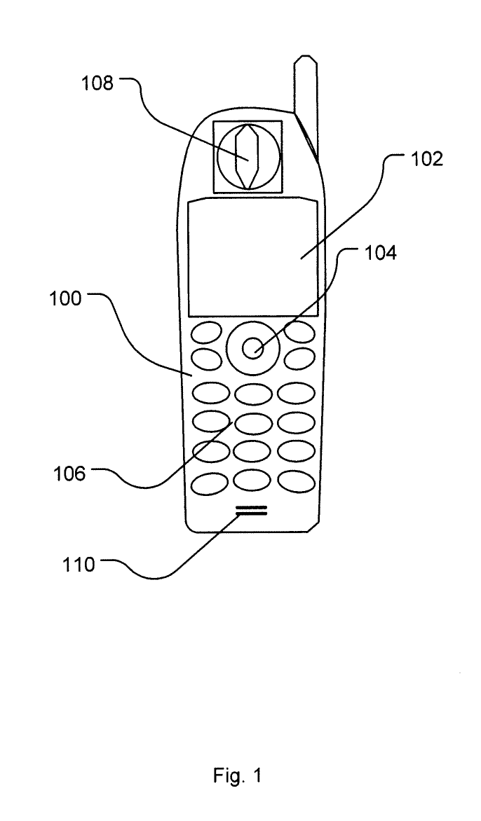

FIG. 1 shows a mobile communication apparatus 100 comprising a display 102 and means 104 for navigating among items (not shown) displayed in a display area 102. The navigation means 104 can be a rotating input, a joystick, a touch pad, but can also be implemented using a touch sensitive display, wherein the displayed items directly can be tapped by a user for selection, or be voice activated via a headset or a built-in microphone.

The mobile communication apparatus can also comprise other elements normally present in such an apparatus, such as a keypad 106, a speaker 108, a microphone 110, a processor (not shown), a memory (not shown), etc.

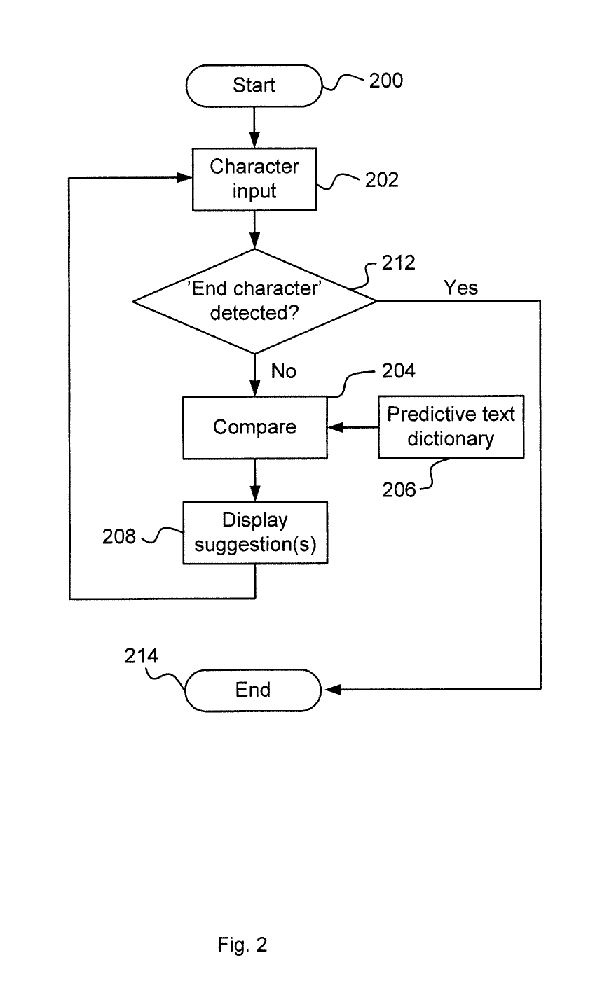

FIG. 2. shows a flow chart illustrating the process of inputting of characters in a handheld communication apparatus, such as a mobile phone, with a predictive text system. The alphanumerical characters can be inputted 202 using a stylus, writing or tapping the characters on the screen or a dedicated area of the apparatus, or by using all or some of the keys on the handheld communication apparatuses full or limited keyboard.

The inputted alphanumerical character is compared 212 with a preset or user configured end-character such as a ‘space’ character. If the inputted 202 alphanumeric character is an end-character 212 the input of that specific character, characters, word, phrase, slang, abbreviation, etc. (hereinafter referred to as a word) is complete 214. If the user continues to enter alphanumerical characters after the end-character, i.e. begins to input a new word, the process restarts 200, else the user have inputted all the words to complete a message and terminates the input process.

If no end-character is detected 212 the character inputting is continued and the alphanumeric character, either by itself or in combination with other previous added characters forming a word or a part of a word, are compared in 204 with characters, words, phrases, abbreviations, slang, etc. stored in a list also known as a predictive text dictionary 206. The predictive text dictionary can be either a full dictionary or only a subset of a full dictionary, thus saving precious memory storage in a handheld communication apparatus with limited memory capacities. The content of the dictionary can be user-configurable in such way that words can be added/removed, new dictionaries can be downloaded and added to, or replace, the dictionary in the handheld apparatus. The dictionary can also be tailored to a specific user by monitoring that users choice of words.

If one or several, complete or partial, matches between an entered word(s) 202 and words in the dictionary are detected, they are made available, e.g. displayed on the screen of the handheld communication apparatus as a list of suggestions, to the user 208. The user is then able to choose any of the available words from the displayed list using the navigation means 104 mentioned in conjunction with FIG. 1. The character input process is continued 202 regardless of if the user chooses a word from the displayed list or continues to input characters. The input process continuous until an ‘end character’ is detected 212 or the character input is terminated by the user.

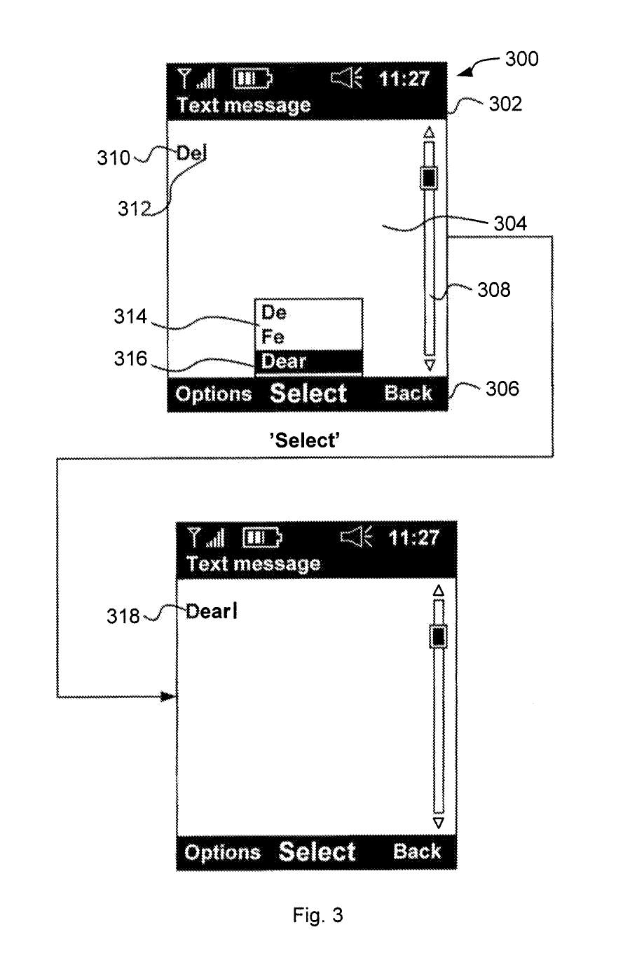

FIG. 3 illustrates an example of a common display view in a handheld communication apparatus 300, running a predictive text system, comprising a general status indication section 302, a softkey bar 306 and a general display area 304. The general status indication section 302 can for example include symbols for battery status, reception quality, speaker on/off, present mode, clock time, etc. The status indication section is not in any way limited to only include these symbols. Thus, other symbols in any shape, form or colors can occur. The softkey bar 306, situated at the bottom of the display view, is operable using the navigation means 104 mentioned in conjunction with FIG. 1. The functions of these softkeys are not limited by the functions indicated in the figure.

The preferred function of the general display area 304, residing between the status indication section 302 at the top and the softkey bar 306 at the bottom, is to display information from running applications in the handheld communication apparatus. In our case the display area 304 also comprise a scroll bar 308, a suggestion list 314, inputted characters 310, and a cursor 312 showing where next character, word, phrase, abbreviation, etc. can be inputted.

The example in FIG. 3 shows how the predictive text systems displays a list of predicted suggestions (hereinafter referred to as a suggestion list) giving the user several words to choose from. A user has, in FIG. 3, entered the characters ‘D’ and ‘e’ 310 which together with a cursor 312 is shown at the top of the display view 300. The matches of these inputted characters, as discussed in detail in conjunction with FIG. 2, to the characters and words in the predictive text dictionary is displayed to the user in a suggestion list 314. The displayed suggestions are ‘De’, ‘Fe’, and ‘Dear’. Since, in this example, the user wants to enter the word ‘Dear’, the user have navigated amongst the suggestions down to the suggestion ‘Dear’, indicated by the black cursor bar 316. The user selects ‘Dear’ by operating ‘Select’ in the softmenu and ‘De’ is replaced by ‘Dear’ 318 as shown in the figure. The user can continue to enter characters, for example a ‘s’ to complete the word ‘Dears’ or enter a ‘space’, indicating that the word is complete and a new word is going to be entered, thus restarting the inputting and prediction process as described in conjunction with FIG. 2.

As described in the background section above there is a potential risk of selecting the “wrong” word when using a predictive text system. An example will clarify how a problem with the predictive text system can arise. Suppose the user of the handheld communication apparatus with a predictive text system is a car repairman. The repairman has been asked by the local vicar to repair his car. The repairman has just finished repairing the vicar's car and because he is in a bit of hurry, and feeling a little guilty for not coming to church lately, he decides to text the vicar telling him that his car is ready. The repairman wants to input the text ‘Dear vicar Thomas, your damaged car is now mended.’ to the vicar.

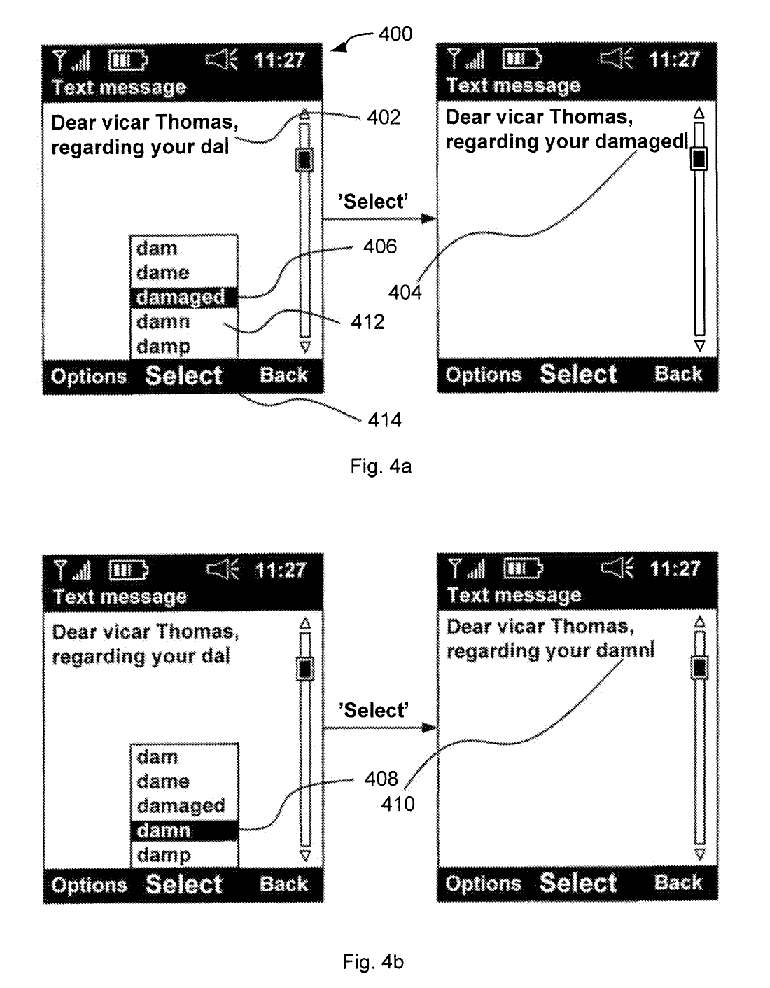

FIG. 4a shows a display view 400 (similar to the one in FIG. 3) where the user (in this case the repairman) has inputted the characters ‘Dear vicar Thomas, your da’ 402 and the predictive text system has given him several suggestions such as ‘dam’, ‘dame’, ‘damage’, ‘damn’, and ‘damp’ in a suggestions list 412. The user has navigated, with the aid of the navigation means mentioned in conjunction with FIG. 1, to the word ‘damaged’ 406 (highlighted by the black bar in the display view). Since the user wants to enter the word ‘damaged’ the user operates ‘Select’ on the softmenu 414, and the word ‘damaged’ is entered. In this case everything has gone right and the user continues to input the rest of the massage. The vicar gets the right message sent to him and all is fine.

However, FIG. 4b shows an example of how easily things can go wrong. FIG. 4b shows a display view where the user (the repairman) has, as in the previous example, inputted the characters ‘Dear vicar Thomas, your da’ and the predictive text system has given him the same suggestions of words 408 as 412 in FIG. 4a. However, in this case the user (repairman) has gotten slippery fingers from the grease and the oil when repairing the vicars car and by mistake slips when navigating and accidentally selects ‘damn’ 408 instead of ‘damaged’ from the suggestions list. Since the user think he has selected ‘damaged’ instead of ‘damn’ 410, and doesn't look at the screen while he continuous to enter the text massage to the vicar, he doesn't discovers his mistake 410. If the user doesn't read through the entered text massage before sending it, a very awkward situation can occur. In this case the repairman can accidentally send a message reading ‘Dear vicar Thomas, your damn car is now mended.’ to the vicar. The accidental text message in combination with the repairman's poor record of attending church on a regular basis can lead to severe consequences both socially and business wise, especially in a small community.

One way of avoiding, or at least reducing, the risk of making such mistakes, as presented in the example above and in the background section, is by using an exceptions list.

An exceptions list, or ‘Bad word’ list, is a list containing the character combinations, words, phrases, abbreviations, etc., that the user, employer, leader, government, etc. wants to avoid using in text massages.

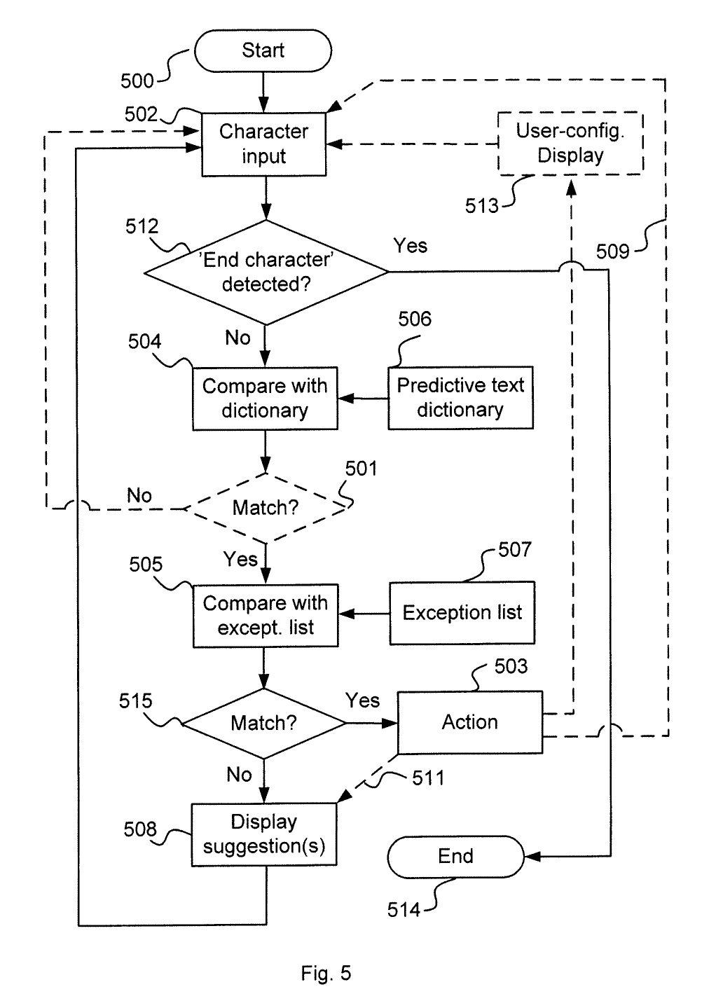

FIG. 5. shows a flow chart illustrating inputting of characters in a handheld communication apparatus, such as a mobile phone, with a predictive text system and an exception list. The alphanumerical characters can be inputted 502 using a stylus, writing or tapping the characters on the screen or a dedicated area of the apparatus, or by using all or some of the keys on the handheld communication apparatuses full or limited keyboard.

As in FIG. 2 the inputted alphanumerical character(s) is compared 512 with a preset or user configured end-character such as a ‘space’ character. If the inputted 502 alphanumeric character is an end-character 512 the input of that specific word is complete 214. If the user continues to enter alphanumerical characters after the end-character, i.e. begins to input a new word, the process restarts 500, else the user have inputted all the words and terminates the input process.

If no end-character is detected 512 the character inputting is continued and the alphanumeric character, either by itself or in combination with other previous added characters forming a word or a part of a word, are then compared in 504 with characters, words, phrases, abbreviations, slang, etc. stored in a predictive text dictionary 506. The predictive text dictionary can be either a full dictionary or only a subset of a full dictionary, thus saving precious memory storage in the handheld communication apparatus. The content of the dictionary can be user-configurable in such way that words can be added/removed, new dictionaries can be downloaded and added to, or replace, the dictionary in the handheld apparatus. The dictionary can also be tailored to a specific user by monitoring that users choice of words.

The inputted word and any matches from the comparison with the predictive text dictionary are then compared 505 against an exception list 507 containing the unwanted or forbidden words. The exception list 507 can either be factory preset, user-configurable or configurable by an application. When it is factory preset it can either be impossible for the user (e.g. hardwired into the memory of the handheld communication apparatus) to change the content of the exception list or it can only be changed via a software upgrade of the handheld communication apparatus (e.g. changing firmware). This can for instance be used when the exception list must be user-tamperproof. If the exception list is user-configurable, the user or a group of users, can add/remove words from the list or download a completely new list by wired or a wireless connection to a server in a network (e.g. Internet, LAN, PC, etc.) or to another handheld device. The exception list can also be modified by an application such as a context sensitive application adding/removing words depending on the current context.

An optional match step 501 can be inserted between the two comparisons 504 and 505. In this embodiment 501 checks if one or several matches have been found in the comparison with the predictive text dictionary. If no matches have been found then another character can immediately be inputted 502 and if one or more matches have been found a comparison of the inputted characters and the matches are compared 505 with the exception list.

If no matches 505 with the exception list 507 is found the matches between inputted word(s) 502 and words in the dictionary 506 (if any matches) are made available, e.g. displayed on the screen of the handheld communication apparatus as a list of suggestions, to the user 508. The user is then able to choose any of the suggested words on the displayed list, if not limited by some action 503, using the navigation means 104 mentioned in conjunction with FIG. 1. The character input process is continued 502 until an ‘end character’ is detected 512 or the character input is terminated by the user. If matches with the exception list are detected, an action(s) 503 is taken. The action(s) 503 can affect which and how word(s) are displayed in the suggestion list 508, it can also affect the character input 502, or it can result in that a user-configured display is displayed to the user. Some of the possible actions that can be taken will be described below using display view examples.

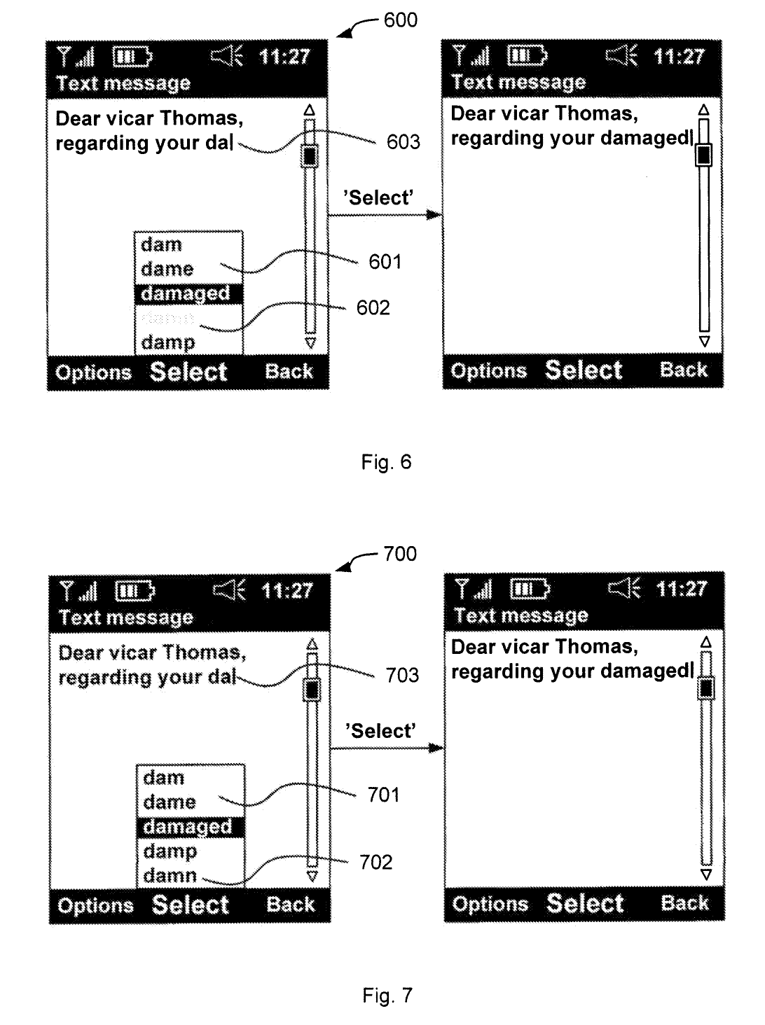

One action 503 is to flag or tag the word(s) that matches a word on the exception list. The word(s) suggested by the predictive text dictionary plus the flagged word(s) could then made available 511 to the user, e.g. displayed on the screen of the handheld communication apparatus as a list of suggestions 508. In contrast to the word(s) suggested by the predictive text dictionary the flagged word(s) are indicated in the suggestion list 508 to signal to the user that the word(s) is not appropriate to use. The indication of a word(s) in the suggestion list can be done in several ways such as by color, font style, animations, blinking, etc. If the word is by mistake selected even though it is indicated in the list, further enhanced indications such as audio signals, and/or tactile indicators (e.g. vibrations) can be used to get the attention of the user. FIG. 6 shows an example of the described action. FIG. 6 shows a display view where the user (the repairman) has entered the text ‘Dear vicar Thomas, your da’ 603 and the predictive text system has provided the user with a suggestion list containing the words, ‘dam’, ‘dame’, ‘damage’, ‘damn’, and ‘damp’. In this case the word ‘damn’ is included in the exception list 507 and has been grayed by an action 503 to indicate to the user that the word is inappropriate to use, since it is often used as a swear word. If the user doesn't notice that the word is indicated and tries to choose the word anyway, additional audio signals, and/or tactile indicators (e.g. vibrations) can be used to enhance the indication, thus avoiding a very embarrassing situation.

A variation of an action above is shown in the display view in FIG. 7. Instead of indicating the flagged word(s) in the suggestion list the inappropriate word ‘damn’ have been placed last 702 in the suggestion list 701. In this way the inappropriate words comes last in the suggestion list thus prioritizing the allowed words placing them at the top of the suggestion list. This will also reduce the probability that the user would select an inappropriate word by mistake.

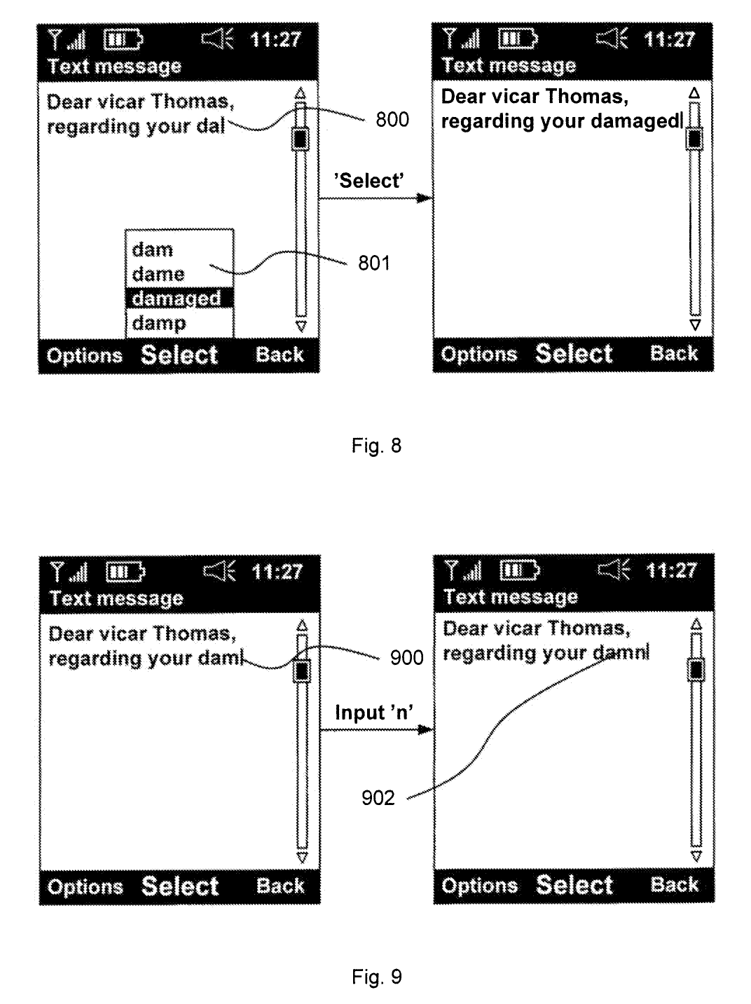

FIG. 8 shows yet another variation of a where the flagged inappropriate word(s) is not made available to the user in the suggestion list. In FIG. 8 shows an example where the flagged word ‘damn’ has been removed by an action 503 and doesn't appear in the displayed list of suggestions 801. An alternative is to remove the whole suggestion list if the user has inputted an inappropriate word. These two actions completely remove the risk of selecting a flagged word by mistake.

However, in some cases a word may have accidentally been deemed inappropriate or the user may want to use an inappropriate word nevertheless. In these cases the user can still input an inappropriate word such as ‘damn’ by entering the characters manually on the handheld communication apparatus keyboard. An example of this is shown in FIG. 9 where the user manually enters a ‘n’ to complete the word ‘damn’.

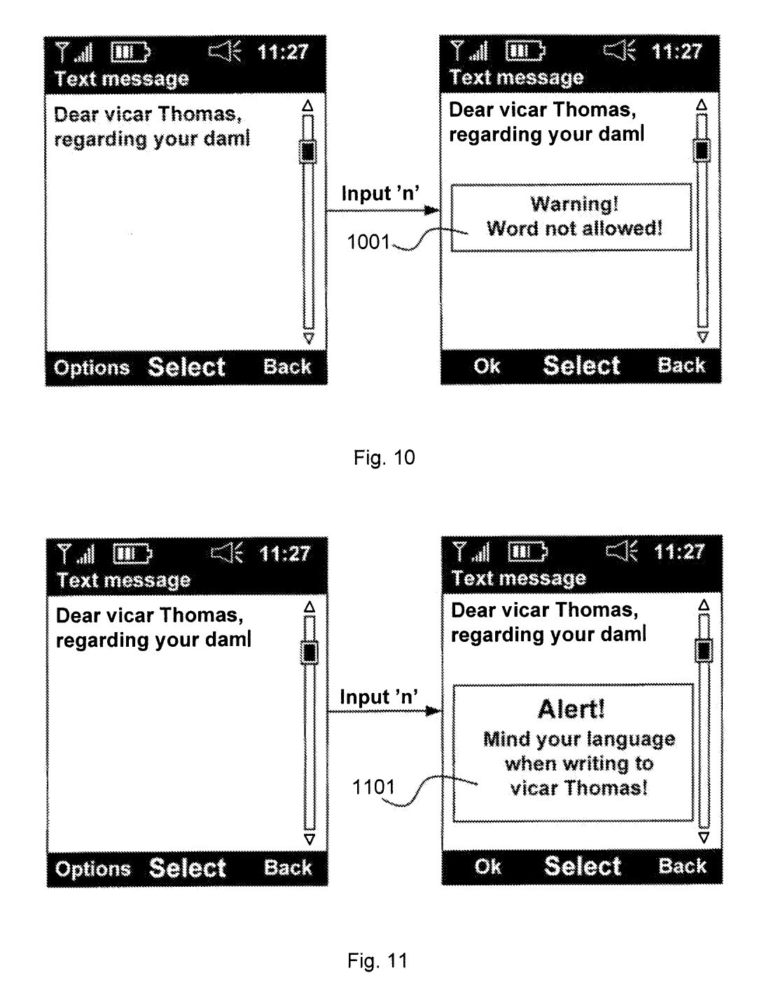

As described above an employer, the government or a religious leader may want to make sure that the words on the exception list never are suggested to the user and that the words not even can be entered manually. One way of doing this is as described above take an action 503 where flagged words are not displayed in the suggestion list 508 (see FIG. 8) and when the user tries to manually input the word ‘damn’, as shown in FIG. 10, a warning message is displayed 513 telling the user that the word the user tries to enter isn't allowed. In FIG. 10 the repairman (the user) for some reason wants to input the word ‘damn’ into the message to the vicar. However, since the word ‘damn’ is in the exception list he is stopped in doing this and a warning massage stating that that word isn't allowed is displayed 1001.

An alternative of the action described in conjunction with FIG. 10 is shown in FIG. 11. In this case can for instance a context sensitive application monitor the behavior of the user and what the user is doing. The application detects that the user is writing a message to the vicar and tailor the exception list thereafter. Since the word ‘damn’ may seem offensive to the vicar it is on the exception list. When the word ‘damn’ is detected the user is alerted with a warning message reminding the repairman that he should mind his language when writing the vicar 1101.

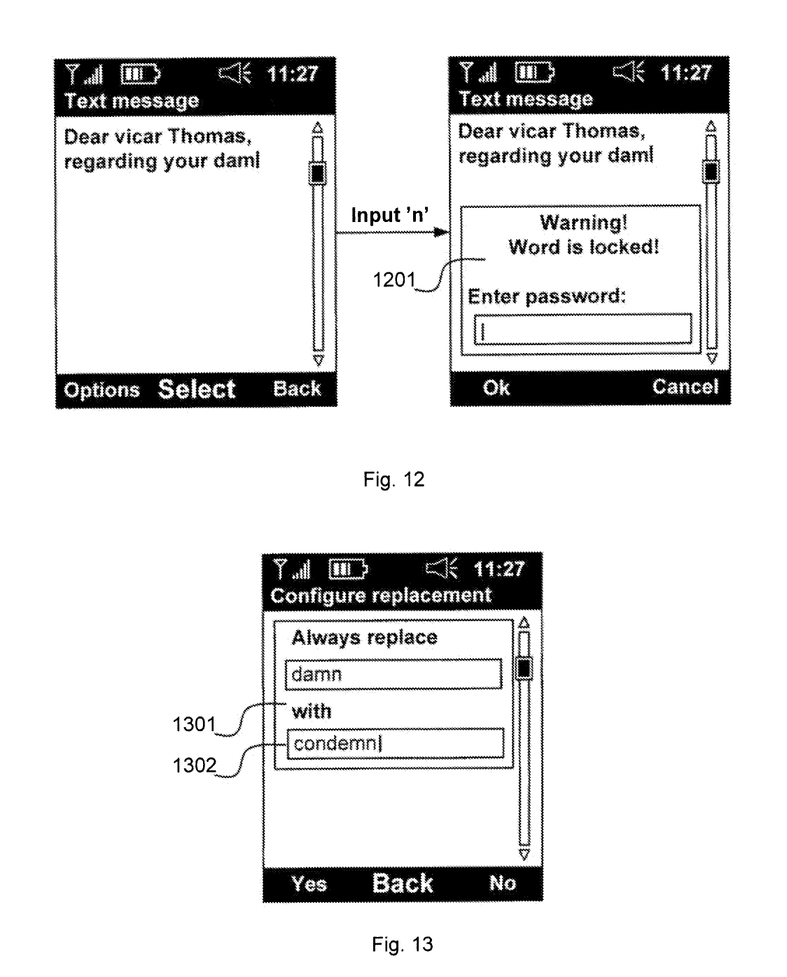

An alternative to the actions described in FIGS. 10 and 11 is shown in FIG. 12. In this case when the user tries to write ‘damn’ a warning message 1201 is shown alerting the user that a password is required to enter the inappropriate word. The password can be managed by the user him self or by another party such as an employer or parent.

Another way of making sure that the words in the exception list isn't used in any messages is by employing an action which always replaces the words on the exception list with another word not on the exception list. In FIG. 13 the display view shows an example of a configuration view 1301 where the use, or an employer, etc., configures to always replace the word ‘damn’ with the word ‘condemn’ 1302. Which word to replace a word with can either be done manually as shown in FIG. 13 or automatically with a dictionary of synonyms or with the help of the predictive text dictionary 506.

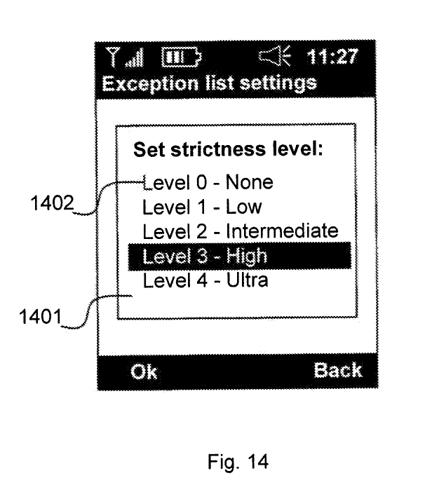

The actions described in FIG. 10 to 12 correspond to using a user-configurable display step 513 in FIG. 5. Which type of message and when and in what context the message is going to be displayed is handled is determined by an action 503 and the user-configured display 514 in FIG. 5. A user-configurable strictness level can be imposed to control which action is going to be taken and which type of user configurable display is going to be displayed. The display view in FIG. 14 shows an example of how a user-configurable strictness level setting 1401 can look like. In this example “Level 0-None” 1402 may correspond to that no restriction and no warnings are used i.e. the exception list is disabled. A “Level 1-Low” may correspond to minimum restrictions meaning that some warnings such as highlighting flagged words (the example in FIG. 6) or placing the flagged words last (the example in FIG. 7) in the suggestion list is enforced. A “Level 2-Intermediate” may correspond to intermediate restrictions meaning that flagged words are removed from the suggestion list (the example in FIG. 8). A “Level 3-High” may correspond to tough restrictions meaning that words found on the exception list are being blocked (not shown in suggestion list and may not be inputted by hand) and warning and/or password signs are displayed (the example in FIG. 10-12). A “Level 4-Ultra” may correspond to the highest restriction level meaning that words in the exception list is being blocked and if the user tries to enter the word manually warning and/or password signs are displayed and for instance a report can be sent to a supervisor (i.e. an employer, a government official) for further investigation.

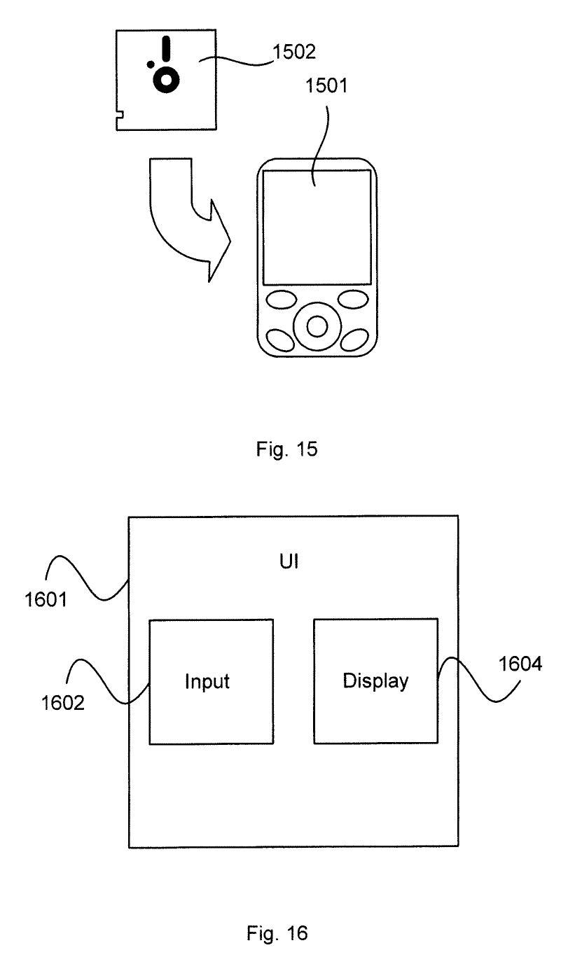

The invention can be computer-implemented, i.e. the media handling is performed on a general or dedicated computerized apparatus 1501, such as a personal computer, a mobile phone, a digital camera, a personal digital assistant, a media player, or other similar apparatus. Instructions for performing the invention can then be executed by the apparatus. These instructions can be loaded into the apparatus 1501 from a computer-readable medium 1502, as exemplary illustrated in FIG. 15, having a data structure stored. The data structure comprises the control instructions, which upon execution causes the apparatus to perform any of the disclosed embodiments as described above.

FIG. 16 illustrates a user interface (UI) 1601 in a portable apparatus having an input interface 1602, which as described in above embodiments can be actuated by a user, and a display interface 1604 for displaying information to the user as described in the above disclosed embodiments.

The action(s) described in above examples can either be factory-preset or user configurable and are not in any way limited by the actions set fourth in the examples above. The actions can for instance also include interaction with the predictive text dictionary 506 limiting access to words in the dictionary, activate a specific dictionary among a plurality of dictionaries, initiate a download of a new dictionary or an add-on to the active dictionary, block a dictionary, etc. In the same way an action can interact with the exception list 503 limiting access to inappropriate words in the list, activate a specific list among a plurality of lists, initiate a download of a new context specific list or an add-on to the active list, block the whole or parts of the list, etc.

1. A method for a portable apparatus, comprising:
enabling inputting characters;
enabling a first comparison of said inputted characters with characters in a list;
enabling a second comparison of matches in said first comparison with characters in an exception list;
and taking action depending on the matches in said second comparison.

2. The method according to claim 1, further comprising modifying said list.

3. The method according to claim 1, further comprising modifying said exception list.

4. The method according to claim 1, further comprising restricting character input depending on said matches in at least one of said first and second comparison.

5. The method according to claim 1, further comprising displaying information depending on said matches in at least one of said first and second comparison.

6. The method according to claim 1, further comprising displaying matches from said first comparisons in said display list and restricting said displaying of matches from said second comparisons in said display list.

7. The method according to claim 6, further comprising enabling selection of said matches displayed in said display list.

8. The method according to claim 6, further comprising restricting said enabled selection of matches from said second comparisons in said display list.

9. A rendering application for a portable apparatus comprising a display and navigation means, said application arranged to cause enabling of character inputting,
enabling a first comparison of said inputted characters with characters in a list,
enabling a second comparison of matches in said first comparison with characters in an exception list, and taking action depending on the matches in said second comparison.

10. The application according to claim 9, further being arranged to modify said list.

11. The application according to claim 9, further being arranged to modify said exception list.

12. The application according to claim 9, further being arranged to restrict character input depending on said matches in at least one of said first and second comparison.

13. The application according to claim 9, further being arranged to display information depending on said matches in at least one of said first and second comparison.

14. The application according to claim 9, further being arranged to display matches from said first comparisons in a display list and to restrict said displaying of matches from said second comparisons in a display list.

15. The application according to claim 14, further being arranged to enable selection of said matches displayed in said display list.

16. The application according to claim 14, further being arranged to restrict said enabled selection of matches from said second comparisons in a display list.

17. An apparatus comprising arranged to enable character inputting,
further arranged to enable a first comparison of said inputted characters with characters in a list,
further arranged to enable a second comparison of matches in said first comparison with characters in a exception list, and further arranged to taking action depending on the matches in said second comparison.

18. The apparatus according to claim 17, further comprising a renderer for modifying said list.

19. The apparatus according to claim 17, further comprising a renderer for modifying said exception list.

20. The apparatus according to claim 17, further comprising a renderer capable of restricting character input depending on said matches in at least one of said first and second comparison.

21. The apparatus according to claim 17, further comprising a renderer capable of displaying information depending on said matches in at least one of said first and second comparison.

22. The apparatus according to claim 17, further comprising a renderer for displaying matches from said first comparisons in a display list and capable of restricting said displaying of matches from said second comparisons in a display list.

23. The apparatus according to claim 22, further comprising a renderer for enabling selection of said matches displayed in said display list.

24. The apparatus according to claim 22, further comprising a renderer for an action capable of restricting said enabling selection of matches from said second comparisons in a display list.

25. A computer-readable medium having computer-executable components comprising instructions for enabling inputting characters, enabling a first comparison of said inputted characters with characters in a list, enabling a second comparison of matches in said first comparison with characters in a exception list, and taking action depending on the matches in said second comparison.

26. The computer-readable medium according to claim 25, further comprise modifying said list.

27. The computer-readable medium according to claim 25, further comprise instructions for modifying said exception list.

28. The computer-readable medium according to claim 25, further comprise instructions for enabling restriction of said character input depending on said matches in at least one of said first and second comparison.

29. The computer-readable medium according to claim 25, further comprising instructions for enabling displaying of information depending on said matches in at least one of said first and second comparison.

30. The computer-readable medium according to claim 25, further comprising instructions for enabling displaying matches from said first comparisons in a display list and restricting said displaying of matches from said second comparisons in a display list.

31. The computer-readable medium according to claim 30, further comprise instructions for enabling selection of said matches displayed in said display list.

32. The computer-readable medium according to claim 30, further comprise instructions for enabling restriction of said enabled selection of matches from said second comparisons in a display list.

33. A user interface comprising a display, and an input receiver, wherein said user interface is arranged to
enabling inputting characters;
enabling a first comparison of said inputted characters with characters in a list;
enabling a second comparison of matches in said first comparison with characters in an exception list;
and taking action depending on the matches in said second comparison.

34. The user interface according to claim 33, wherein said input receiver further comprises a touch sensitive matrix arranged for enabling input of an image in said area by actuation of said touch sensitive matrix.

35. The user interface according to claim 28, wherein said input receiver is arranged to receive a user input on selection of side to be displayed among said content side and said backside.

36. A user interface comprising a display, and an input receiver, wherein said user interface is arranged to; enable a portable apparatus for character input where said inputted characters are compared in a first comparison, with words in a list, and a second comparison, with words in an exception list, and where matches of said comparisons are listed in a display list; display said display list in said display.

37. The user interface according to claim 36, wherein said display is arranged to display information depending on said matches in at least one of said first and second comparison.

38. The user interface according to claim 36, wherein said input receiver is arranged to display matches from said first comparisons in said display list and restricting said displaying of matches from said second comparisons in said display list.
